(19) United States
(12) Patent Application Publication
(10) Pub. No.: US 2017/0248375 A1
(43) Pub. Date: Aug. 31, 2017

(54) HEAT EXCHANGER AND STORAGE DEVICE FOR COLD VEHICLE STARTUP WITH REGENERATIVE CAPABILITY

(71) Applicant: BorgWarner Inc., Auburn Hills, MI (US)

(72) Inventors: Christopher E. BLAIR, Fenton, MI (US); Brett J. LEE, Portland, OR (US)

(21) Appl. No.: 15/507,563

(22) PCT Filed: Sep. 2, 2015
(86) PCT No.: PCT/US2015/048011

§ 371 Date: Feb. 28, 2017

Related U.S. Application Data
(60) Provisional application No. 62/046,220, filed on Sep. 5, 2014.

(51) Int. Cl. F28D 20/02; F02N 19/04; F01P 3/20; F01M 5/00; B60H 1/00; F16H 57/04

(52) U.S. Cl. CPC F28D 20/02; B60H 1/00492; F16H 57/0417; F16H 57/0483; F01P 3/20; F01M 5/001; F02N 19/04; F28D 2021/008

(57) ABSTRACT

A product is provided with a container holding a heat storage medium. A fluid is entrained in a conduit that is routed through the container and routed through a heat generating system. An initiator is operably connected to the container. The heat storage medium is responsive to the generation of a signal from the initiator. When the heat generating system is in operation, the fluid is moved through the conduit so that when the heat generating system is operating, heat generated as a by-product is entrained in the fluid, passed through the container via the conduit and transferred to the heat storage medium. When desirable to provide heat to the heat generating system, the initiator is operated to expose the heat storage medium to a signal triggering the release of heat from the heat storage medium that is transferred through the fluid to the heat generation system.

### CROSS-REFERENCE TO RELATED APPLICATION

This application claims the benefit of U.S. Provisional Application Ser. No. 62/046,220 filed Sep. 5, 2014.

### TECHNICAL FIELD

The field to which the disclosure generally relates includes heat exchangers, storage devices and methods of starting up a vehicle.

### BACKGROUND

In operation, many systems particularly those in vehicles with internal combustion engines produce excess heat that is typically dissipated through cooling systems when operating and could benefit from additional heating at other times to allow the system to reach operating temperature more quickly.

### SUMMARY OF SELECT ILLUSTRATIVE VARIATIONS

A number of variations may include a product with a container having a first flow path through the container for a working fluid, a heat storage medium received in the container, a heat transfer surface may be interposed between the heat storage medium and the working fluid so that heat may be transferred from at least one of the heat storage medium to the working fluid, or from the working fluid to the heat transfer medium. An initiator may be operatively connected to the container for initiating heat release from the heat storage medium.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a product including a container having a heat storage medium, and an initiator operatively connected to the container for initiating the release of heat from the heat storage medium according to a number of variations.

FIG. 2 is a graphic illustration of a heat release and regeneration cycle including heating, phase change and cooling of a heat storage medium with subcooling which may occur in a number of variations.

FIG. 3 is a graphic illustration of a heat release and regeneration cycle, including heating, phase change, controlled latent heat release and cooling of a heat storage medium with subcooling and utilizing crystal nucleation which may occur in a number of variations.

FIG. 4 is a schematic illustration of a product including a container having a heat storage medium, and an initiator operatively connected to the container for initiating the release of heat from the heat storage medium according to a number of variations.

FIG. 5 is a schematic illustration of a heat exchanger including heat transfer surfaces between multiple fluids and a heat storage medium according to a number of variations.

FIG. 6 is a schematic illustration of a product including a container having a heat storage medium according to a number of variations.

### DETAILED DESCRIPTION OF ILLUSTRATIVE VARIATIONS

The following description of the variations is merely illustrative in nature and is in no way intended to limit the scope of the invention, its application, or uses.

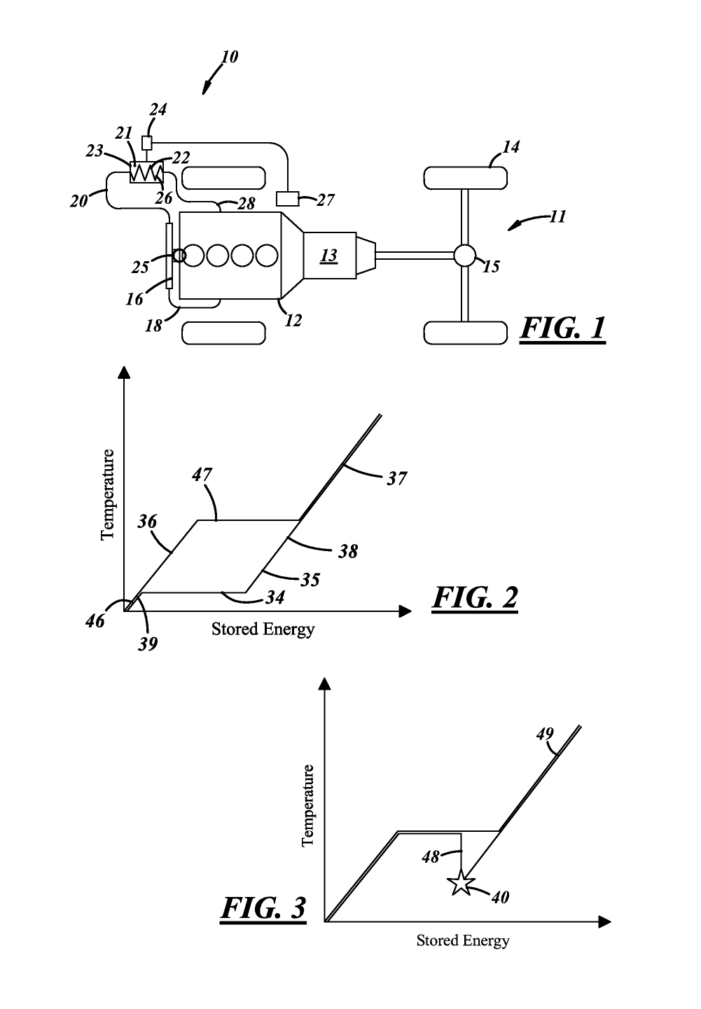

FIG. 1 illustrates a number of variations which may include a product 10 that may be associated with a vehicle 11 which may include a heat generating system such as internal combustion engine 12 operatively connected to drive a plurality of wheels 14 through transmission 13 and differential 15. The vehicle may include a radiator 16 that may be part of a circuit for conveying fluid; including line 18 connected from the radiator to an engine block of the engine 12, line 20 operatively connected from the radiator to a heat exchanger 22 in container 23, and line 28 operatively connected from heat exchanger 22 to the cooling system of engine 12. The circuit may contain coolant which serves as a working fluid in the circuit that may flow with assistance of the engine's water pump 25. Inside the container may be a heat storage medium contained around the heat exchanger 22 through which the working fluid flows. The wall of the fluid carrying line of the circuit in container 23 serves as a heat exchange surface. A generator which may be an initiator 24 may be operatively connected to the container 23 to initiate the release of heat from the heat storage medium. The initiator 24 is operatively connected to a controller 27 on board the vehicle 11 for select operation of the initiator that may be controlled according to a defined algorithm.

According to a number of variations, the heat storage medium 21 may be selected for its ability undergo controllable exothermic process to store and release heat energy. The controllable nature of this reaction eliminates the need for expensive insulation systems used in other heat storage systems. The process in question could be used as a reversible chemical reaction, phase change or other process with the appropriate thermal characteristics. Examples of suitable material for the heat storage medium may include hydrated salts of which sodium-acetate in aqueous solution is one example.

The heat storage medium may surround a heat exchange surface 26, which is associated with the outside of the conduit's wall. On the opposite (inside) of the wall of the circuit's line, another heat exchange surface may be in contact with a working fluid to be heated or to provide heat. The working fluid may be an engine coolant in the present variation. In other variations the working fluid may be engine oil, transmission fluid, differential fluid, air, or another working fluid selected for use according to the heat generating system's requirements. At normal operating temperatures, the heat storage medium is regenerated using heat absorbed from the working fluid. When it is desirable to release heat from the heat storage medium and return it for use such as by the engine as may be required during a cold start event, the heat storage medium may be triggered to release its storage thermal energy. This energy is transferred to the working fluid via the heat exchange surface 23. The resulting increase in working fluid temperature that is returned to the engine results in improved fuel efficiency through reduced viscous shear as well as other temperature related effects.

A phase change material may be utilized in the heat exchanger 22. According to a number of variations, a phase change material with a high tendency for subcooling may be selected as the heat storage medium. The subcooling ability of the heat storage medium allows the material to store latent heat well below the theoretical dissolution or melting temperature of the material. FIG. 2 illustrates the temperature versus stored energy cycle of a phase change material with subcooling selected as the heat storage medium. Beginning at the origin, the temperature of the material is below its phase change temperature. As heat is added in stage 46 the temperature increases during heating or regeneration 36 and at the phase change temperature 47 heat storage continues at a second rate while phase change occurs which may entail melting. When phase change is complete and the material may be in a complete liquid state, as heat input continues, the temperature continues to rise through stage 37 until equilibrium with the heat source from the working fluid is established.

When the heat source is removed, as is the case when a vehicle is turned off and parked, the material cools and the temperature may gradually drop over time as shown by the cooling curve 35. Unlike materials that solidify at the same temperature at which melting occurred, the selected material will solidify at a lower phase change temperature 34 than the phase change temperature of melting 47. The material selected may have a phase change temperature 34 that is below the normal range of temperatures to which the material will be exposed. After the heat source is removed, the temperature may proceed to drop well below the melting phase change temperature 47 of the heat storage medium resulting in substantial subcooling below the phase change temperature 47 through third stage 35 as shown in FIG. 2. As shown in FIG. 3 during the release 48 of heat from the heat storage medium and the associated heating thereof, stored energy is released and the temperature of the heat storage medium increases until solidification or other phase change is completed. Curve 49 shows the heating cycle of the heat storage medium.

The heat storage medium may be a phase change material of the type with latent heat storage properties which may be achieved through a solid-solid or solid-liquid change. Utilizing these types of materials avoids large volumes or high pressures needed to store a gas phase material. As the phase change material is exposed to heat, its temperature increases, and when the phase change temperature is reached, large amounts of heat are absorbed and stored in the phase altered material. The stored latent heat is then available for extraction and use when desired.

As may be needed during a cold start event, heat is released through a commanded phase change. This phase change may be accomplished with a nucleation type initiator. The nucleation initiator can be any type capable of creating a pressure wave strong enough to initiate crystal nucleation of the heat storage medium. The nucleation initiator may be an acoustic pressure generating device that can selectively flood the interior of container 23 with acoustic pressure waves thereby subjecting the heat storage medium to the pressure waves. This initiates crystal nucleation in the heat storage medium and an associated phase change and rapid release 48 of heat as shown in FIG. 3. The crystal nucleation point 40 forced by the pressure waves, initiates the rapid temperature increase and the release of heat during heating 48.

Selecting a heat storage medium with subcooling that has a resolidification temperature below its melting temperature, ensures the ability to rapidly extract heat at ambient conditions such as those encountered by a parked vehicle. At ambient temperatures, the heat storage medium will remain in its higher level phase, for example liquid. Triggering a phase change in the heat storage medium through the initiator 24 initiates a phase change such as resolidification and a rapid release of heat 48. This phase change is triggered at temperature that is higher than the phase change temperature 34. As the generated heat is extracted for use through the working fluid, the temperature of the heat storage medium will begin to drop after the triggered phase change is complete.

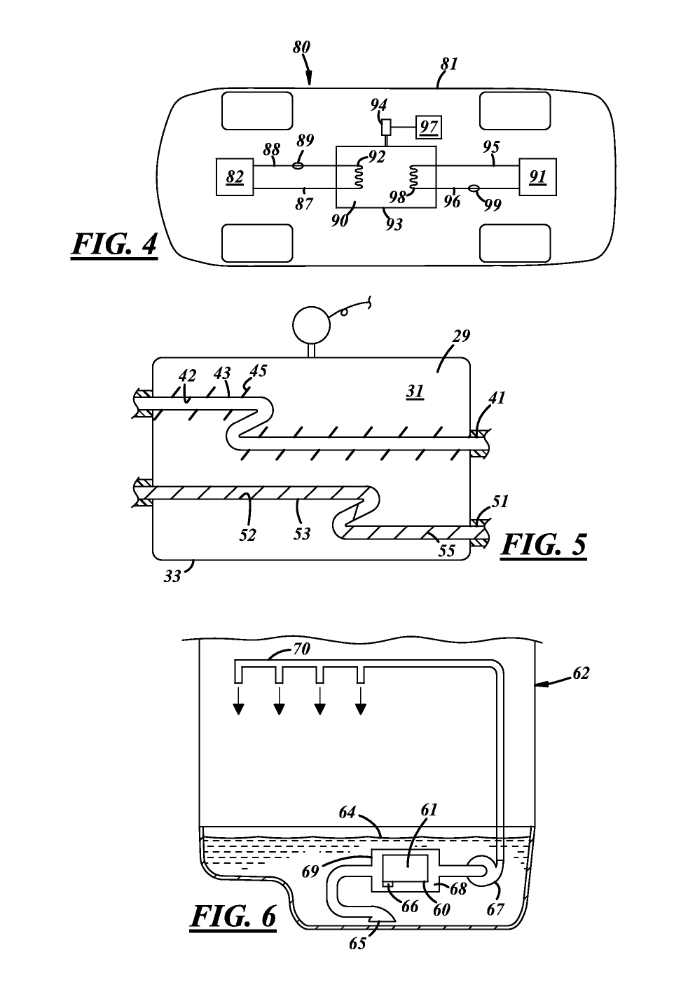

FIG. 4 illustrates a number of variations which may include a product 80 that may be associated with a vehicle 81 which may include a heat generating system 82. The heat generating system may include a conduit for conveying a first fluid within a circuit including the heat generating system 82, line 88 connected from the heat generating system 82 to a heat exchanger 92 in container 93, and line 87 connected from the heat exchanger 92 to the heat generating system 82. A fluid moving device may be provided 89, which may be a pump, fan or other appropriate device to move the selected fluid through the circuit. The inside and the outside of the wall of the heat exchanger line of the conduit in container 93 serve as heat exchange surfaces.

The product 80 may also include a heat utilizing system 91. The heat utilizing system may be part of a system for conveying a second fluid through a circuit including line 96 connected from the heat utilizing system 91 to a heat exchanger 98 in container 93, and line 95 connected from the heat utilizing device 91 to the heat exchanger 98 in container 93, and may include a fluid moving device 99, which may be a pump, fan or other appropriate device to move the selected fluid through the system. The inside and outside surfaces of the wall of the heat exchanger line of the conduit in container 93 serve as heat exchange surfaces. An initiator 94 may be operatively connected to the container 93 to initiate the release of heat from the heat storage medium. The initiator 94 is operatively connected to a controller 97 on board the vehicle 81 and may be operated according to a defined algorithm.

When the product 110 is operating in a heat storage mode, fluid moving device 89 moves the first fluid through the heat exchanger 92 carrying heat from the heat generating device 82 for transfer to the heat storage medium 90. When the product 80 is operated in a heat usage mode, fluid moving device 99 moves the second fluid through the heat exchanger 98 and the controller 97 causes the initiator 94 to send a signal into the container 93 initiating the release of heat energy which is transferred to the second fluid through the heat exchanger 98. The second fluid is heated and moved through line 95 to the heat utilizing device 91 where it is used to provide heat to the desired system

The initiator may be triggered when heat is needed which may include the steps of checking if the operation of the heat utilizing device is incipient or initiated; checking if the temperature in the heat generating device is below a threshold, checking if ambient temperature is below a threshold; and checking if stored heat in the heat storage medium is adequate. If the results are positive, prior to triggering the initiator the fluid moving device 99 may be started and the initiator triggered prior to starting the heat utilizing device.

The steps of starting the vehicle may include starting the vehicle and the heat utilizing device; triggering the initiator at a temperature that is below the phase change temperature, which initiates a phase change of the heat storage medium; extracting heat from the heat storage medium; and using the extracted heat in the heat utilizing device.

A vehicle is typically started after a long period of time which may be several hours or even overnight wherein the engine has not been running and the systems in the vehicle are at or close to the ambient temperature. Time is required to heat a typical engine, transmission, differential, and other systems during operation. The operation of vehicle systems is typically optimized at temperatures significantly higher than ambient.

Providing a supplementary source of heat at startup increases initial operating temperatures and results in improved efficiency, improved fuel consumption and reduced emissions.

Referring to FIG. 5, in a number of variations the container may include a compartment 29 for storing a heat storage medium 31. The heat storage medium 31 and the working fluid may be separated by the wall of the conduit lines that extend through the container, preferably in a circuitous route. The container 33 may also include a first conduit in the form of line 41 for flowing a working fluid from a heat generating device there through. Line 41 may have a first heat transfer surface 42 on the inside of its wall and may have an enhanced second heat transfer surface 43 on the outside of its wall with features in the form of elements 45 which may be ribs, fins, or other extending heat conducting features that enhance heat transfer from the working fluid to the heat storage medium by enlarging the heat transfer surface between. The container 33 may include a second conduit in the form of line 51 for flowing a second working fluid there through from a system that is capable of utilizing heat. Line 51 may have a first heat transfer surface 52 on the inside of its wall enhanced with elements 55 which may be ribs, fins, or other extending heat conducting features that enhance heat transfer from the heat storage medium to the second working fluid by enlarging the heat transfer surface there between, and may have a second heat transfer surface 53 on the outside of its wall.

As shown in FIG. 6 in a number of variations a container may be positioned directly in the sump of a heat generating system 62 where it may be submerged in the working fluid 64, partially submerged, or disposed above the oil level. Container 60 may be filed with a heat storage material and may include an initiator 66. In operation pump 67 may effect the flow of fluid 64 directly over the heat exchange surface on the outside of container 60 through flow space 68 before distribution for use in the heat generating system 62. When operating at normal temperatures, pump 67 may move heated fluid 64 over container 60 to store heat in the heat storage material. During startup of the heat generating system when additional heat is desired, the initiator 66 may trigger a phase change and heat release which is transferred to the fluid 64 as it is pumped over the outside surface of container 60.

The following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still considered to be within the scope of the invention.

Variation 1 may include a product with a heat generating system, the product having a heat storage medium constructed and arranged to receive and store heat from the heat generating system. The product is constructed and arranged to trigger, extract, and use the stored heat. The heat storage medium receives heat from the heat generating system during which heat storage in the heat storage medium increases at a first rate to a point where a phase change of the heat storage medium occurs and at a second rate during the phase change of the energy storage medium at a phase change temperature. The second rate is substantially higher than the first rate. The extraction and use of heat by the product is triggered by a generator at a temperature that is lower than the phase change temperature

Variation 2 may include a product with container that contains a heat storage medium; a fluid entrained in a conduit that is routed through the container and routed through a heat generating system; a fluid moving device in the conduit; a first heat exchange surface on the outside of the first conduit within the container that is in contact with the heat storage medium; a second heat exchange surface on the inside of the first conduit inside the container that is in contact with the fluid; and an initiator operably connected to the container, the heat storage medium being responsive to the generation of a signal being introduced into the container from the initiator; wherein when the heat generating system is in operation, the fluid moving device operates to move the fluid through the conduit so that when the heat generating system is operating, heat generated as a by-product is entrained in the fluid, passed through the container via the conduit and transferred to the heat storage medium through the first and second heat exchange surfaces, wherein when desirable to provide heat to the heat generating system, the initiator is operated to expose the heat storage medium to a signal triggering the release of heat from the heat storage medium that is transferred through the fluid to the heat generation system.

Variation 3 may include a product according to variation 1 wherein the heat storage medium is positioned in a container in the heat generating system and wherein a working fluid from a sump of the heat generating system is passed over the container to store and extract heat.

Variation 4 may include product as set forth in variation 2 wherein when heat is transferred to the heat storage medium the amount of stored energy versus temperature increases at a first rate to a first point where phase change of the heat storage medium occurs wherein the rate of stored energy to temperature increases at a second rate that is substantially higher that the first rate during a phase change of the energy storage medium at a phase change temperature and wherein the transfer of heat to the heat generation system is triggered at a temperature that is lower than the phase change temperature.

Variation 5 may include a product according to variation 2 or 4 wherein the heat generating system is an engine cooling system and the fluid is coolant from the engine cooling system.

Variation 6 may include a product as set forth in variation 2 or 4 wherein the heat generating system is a heating system of a passenger compartment and the fluid is air from the passenger compartment.

Variation 7 may include a product as set forth in variation 2, 3 or 4 wherein the heat generating system is a transmission and the fluid is transmission fluid from the transmission.

Variation 8 may include a product as set forth in variation 2, 3 or 4 wherein the heat generating system is an axle differential and the fluid is lubricant from the axle differential.

Variation 9 may include a product as set forth in variation 2, 3 or 4 wherein the heat generating system is an engine and the fluid is lubricating oil from the engine.

Variation 10 may include a product for a vehicle with a container that contains a heat storage medium with a nucleation characteristic; a fluid entrained in a conduit that is routed through the container and routed through a vehicle system; a pump in the conduit; a first heat exchange surface on the outside of the conduit within the container that is in contact with the heat storage medium; a second heat exchange surface on the inside of the conduit inside the container that is in contact with the fluid; a generator, the heat storage medium being responsive to the generation of pressure being introduced into the container from the pressure generator; wherein when the vehicle is in operation the pump operates to move the fluid through the first conduit so that when the vehicle is operating, heat generated as a by-product is entrained in the fluid, passed through the container and transferred to the heat storage medium, causing the heat storage medium to be in a first phase; wherein when desirable to provide heat to the vehicle system the generator is operated to expose the heat storage medium to a signal triggering the nucleation characteristic and a transition of the heat storage medium to a second phase resulting in the release of heat from the heat storage medium that is transferred through the fluid to the vehicle system.

Variation 11 may include a product as set forth in variation 10 wherein the vehicle system is an engine cooling system and the fluid is coolant from the engine cooling system.

Variation 12 may include a product as set forth in variation 10 wherein the vehicle system is a heating system of a passenger compartment and the fluid is air from the passenger compartment.

Variation 13 may include a product as set forth in variation 10 wherein the vehicle system is a power transmission device and the fluid is oil from the power transmission device.

Variation 14 may include a product as set forth in variation 10 wherein the vehicle system is an axle differential and the fluid is lubricant from the axle differential.

Variation 15 may include a product as set forth in variation 10 wherein the heat generating system is an engine and the fluid is lubricating oil from the engine.

Variation 16 may include a product with a container that contains a heat storage medium with a nucleation characteristic; a first fluid entrained in a first conduit that is routed through the container and routed through a first vehicle system; a first pump in the first conduit; a first heat exchange surface on the outside of the first conduit within the container that is in contact with the heat storage medium that is selected to change phases, the first heat exchange surface having elements to promote heat transfer; a second heat exchange surface on the inside of the first conduit inside the chamber that is in contact with the first fluid; a second fluid entrained in a second conduit that is routed through the container and routed through a second vehicle system; a second pump in the second conduit; a third heat exchange surface on the outside of the second conduit within the container that is in contact with the heat storage medium; a fourth heat exchange surface on the inside of the second conduit within the container that is in contact with the second fluid, the fourth heat exchange surface having elements to promote heat transfer; and a passage from the container leading to a chamber containing an acoustic pressure wave generator, the heat storage medium being responsive to the generation of acoustic pressure waves being introduced into the container from the acoustic pressure wave generator through the passage into the container; wherein when the vehicle is in operation the first pump operates to move the first fluid through the first conduit so that when the vehicle is operating, heat generated as a by-product is entrained in the first fluid, passed through the container and heat is transferred to the heat storage medium, causing the heat storage medium to be in a first phase; wherein when the vehicle operation is stopped, the first pump is selectively operated to capture heat from an increased temperature in the first vehicle system; wherein when desirable to provide heat to the second vehicle system the acoustic pressure wave generator is operated to expose the heat storage medium to an acoustic pressure wave initiating the nucleation characteristic and a transition of the heat storage medium to a second phase resulting in the release of heat from the heat storage medium that is transferred through the second fluid to the second vehicle system.

Variation 17 may include a product as set forth in variation 16 wherein the first vehicle system is an engine cooling system, the first fluid is coolant from the engine cooling system, the second vehicle system is a heating system of a passenger compartment and the fluid is air from the passenger compartment.

Variation 18 may include a product as set forth in variation 16 wherein the first vehicle system is an engine cooling system, the first fluid is coolant from the engine cooling system, the second vehicle system is an engine intake system and the second fluid is air.

Variation 19 may include a product as set forth in variation 16 wherein the first vehicle system is a transmission, the first fluid is transmission oil from the transmission, the second vehicle system is an engine cooling system and the second fluid is coolant from the engine cooling system.

Variation 20 may include a product as set forth in variation 16 wherein the first vehicle system is an axle differential, the first fluid is lubricant from the axle differential, the second vehicle system is an engine cooling system and the second fluid is coolant from the engine cooling system

Variation 21 may include a product as set forth in variation 16 wherein the heat generating system is an engine and the fluid is lubricating oil from the engine.

Variation 22 may include a product as set forth in any of variations 16-21 wherein when heat is transferred to the heat storage medium from the first vehicle system the amount of stored energy versus temperature increases at a first rate to a first point where phase change of the heat storage medium occurs wherein the rate of stored energy versus temperature increases at a second rate that is substantially higher that the first rate during a phase change of the energy storage medium at a phase change temperature and wherein when heat is transferred to the second vehicle system the rate of energy release versus temperature decreases at a third rate through a range of subcooling that is at a range of temperatures lower than the phase change temperature.

Variation 23 may include a method of starting a vehicle having a heat utilizing system, a heat storage medium that when heated undergoes a phase change at a phase change temperature, and an initiator. The method may include the steps of starting the vehicle and the heat utilizing system; triggering the initiator at a temperature that is below the phase change temperature, which initiates a phase change of the heat storage medium; extracting heat from the heat storage medium; and using the extracted heat in the heat utilizing system.

The above description of select variations within the scope of the invention is merely illustrative in nature and, thus, variations or variants thereof are not to be regarded as a departure from the spirit and scope of the invention.

What is claimed is:

1. A product with a heat generating system, the product having a heat storage medium constructed and arranged to receive and store heat from the heat generating system wherein the product is constructed and arranged to trigger, extract, and use the stored heat, the heat storage medium receiving heat from the heat generating system during which heat storage in the heat storage medium increases at a first rate to a point where a phase change of the heat storage medium occurs and increases at a second rate during the phase change of the energy storage medium at a phase change temperature, the second rate being substantially higher than the first rate and wherein the extraction and use of heat by the product is triggered by a generator at a temperature that is lower than the phase change temperature.

2. A product with:
a container that contains a heat storage medium;
a fluid entrained in a conduit that is routed through the container and routed through a heat generating system;
a fluid moving device in the conduit;
a first heat exchange surface on the outside of the first conduit within the container that is in contact with the heat storage medium;
a second heat exchange surface on the inside of the first conduit inside the container that is in contact with the fluid;
an initiator operably connected to the container, the heat storage medium being responsive to the generation of a signal being introduced into the container from the initiator;
wherein when the heat generating system is in operation, the fluid moving device operates to move the fluid through the conduit so that when the heat generating system is operating, heat generated as a by-product is entrained in the fluid, passed through the container via the conduit and transferred to the heat storage medium through the first and second heat exchange surfaces, wherein when desirable to provide heat to the heat generating system, the initiator is operated to expose the heat storage medium to a signal triggering the release of heat from the heat storage medium that is transferred through the fluid to the heat generation system.

3. A product according to claim 1 wherein the heat storage medium is positioned in a container in the heat generating system and wherein a working fluid from a sump of the heat generating system is passed over the container to store and extract heat.

4. A product according to claim 1 wherein when heat is transferred to the heat storage medium the amount of stored energy versus temperature increases at a first rate to a point where phase change of the heat storage medium occurs wherein the rate of stored energy to temperature increases at a second rate that is substantially higher that the first rate during a phase change of the energy storage medium at a phase change temperature and wherein the transfer of heat to the heat generation system is triggered at a temperature that is lower than the phase change temperature.

5. A product according to claim 1 wherein the heat generating system is an engine cooling system and the fluid is coolant from the engine cooling system.

6. A product according to claim 1 wherein the heat generating system is a heating system of a passenger compartment and the fluid is air from the passenger compartment.

7. A product according to claim 1 wherein the heat generating system is a transmission and the fluid is transmission fluid from the transmission.

8. A product according to claim 1 wherein the heat generating system is an axle differential and the fluid is lubricant from the axle differential.

9. A product according to claim 1 wherein the heat generating system is an engine and the fluid is lubricating oil from the engine.

10. A product for a vehicle with:
a container that contains a heat storage medium with a nucleation characteristic;
a fluid entrained in a conduit that is routed through the container and routed through a vehicle system;
a pump for moving the fluid through the conduit;
a first heat exchange surface on the outside of the conduit within the container that is in contact with the heat storage medium; a second heat exchange surface on the inside of the conduit inside the container that is in contact with the fluid;
a generator, the heat storage medium being responsive to the generation of pressure being introduced into the container from the pressure generator;
wherein when the vehicle is in operation the pump operates to move the fluid through the first conduit so that when the vehicle is operating, heat generated as a by-product is entrained in the fluid, passed through the container and transferred to the heat storage medium, causing the heat storage medium to be in a first phase wherein when desirable to provide heat to the vehicle system the generator is operated to expose the heat storage medium to a signal triggering the nucleation characteristic and a transition of the heat storage medium to a second phase resulting in the release of heat from the heat storage medium that is transferred through the fluid to the vehicle system.

11. A product according to claim 7 wherein the vehicle system is an engine cooling system and the fluid is coolant from the engine cooling system.

12. A product according to claim 7 wherein the vehicle system is a heating system of a passenger compartment and the fluid is air from the passenger compartment.

13. A product according to claim 7 wherein the vehicle system is a power transmission device and the fluid is oil from the power transmission device.

14. A product according to claim 7 wherein the vehicle system is an axle differential and the fluid is lubricant from the axle differential.

15. A product according to claim 7 wherein the heat generating system is an engine and the fluid is lubricating oil from the engine.

16. A product for a vehicle with:
a container that contains a heat storage medium with a nucleation characteristic;
a first fluid entrained in a first conduit that is routed through the container and routed through a first vehicle system;
a first pump in the first conduit;
a first heat exchange surface on the outside of the first conduit within the container that is in contact with the heat storage medium that is selected to change phases, the first heat exchange surface having ribs to promote heat transfer; a second heat exchange surface on the inside of the first conduit inside the chamber that is in contact with the first fluid;
a second fluid entrained in a second conduit that is routed through the container and routed through a second vehicle system;
a second pump in the second conduit;
a third heat exchange surface on the outside of the second conduit within the container that is in contact with the heat storage medium;
a fourth heat exchange surface on the inside of the second conduit within the container that is in contact with the second fluid, the fourth heat exchange surface having ribs to promote heat transfer;
a passage from the container leading to a chamber containing an acoustic pressure wave generator, the heat storage medium being responsive to the generation of acoustic pressure waves being introduced into the container from the acoustic pressure wave generator through the passage into the container;
wherein when the vehicle is in operation the first pump operates to move the first fluid through the first conduit so that when the vehicle is operating, heat generated as a by-product is entrained in the first fluid, passed through the container and transferred to the heat storage medium, causing the heat storage medium to be in a first phase; wherein when the vehicle operation is stopped, the first pump is selectively operated to capture heat from an increased temperature in the first vehicle system; wherein when desirable to provide heat to the second vehicle system the acoustic pressure wave generator is operated to expose the heat storage medium to an acoustic pressure wave initiating the nucleation characteristic and a transition of the heat storage medium to a second phase resulting in the release of heat from the heat storage medium that is transferred through the second fluid to the second vehicle system.

17. A product according to claim 14 wherein the first vehicle system is an engine cooling system, the first fluid is coolant from the engine cooling system, the second vehicle system is a heating system of a passenger compartment and the fluid is air from the passenger compartment.

18. A product according to claim 14 wherein the first vehicle system is an engine cooling system, the first fluid is coolant from the engine cooling system, the second vehicle system is an engine intake system and the second fluid is air.

19. A product according to claim 14 wherein the first vehicle system is a transmission, the first fluid is transmission oil from the transmission, the second vehicle system is an engine cooling system and the second fluid is coolant from the engine cooling system.

20. A product according to claim 14 wherein the first vehicle system is an axle differential, the first fluid is lubricant from the axle differential, the second vehicle system is an engine cooling system and the second fluid is coolant from the engine cooling system.

21. A product according to claim 14 wherein the heat generating system is an engine and the fluid is lubricating oil from the engine.

22. A product according to claim 14 wherein when heat is transferred to the heat storage medium from the first vehicle system the amount of stored energy versus temperature increases at a first rate to a first point where phase change of the heat storage medium occurs wherein the rate of stored energy versus temperature increases at a second rate that is substantially higher that the first rate during a phase change of the energy storage medium at a phase change temperature and wherein when heat is transferred to the second vehicle system the rate of energy release versus temperature decreases at a third rate through a range of subcooling that is at a range of temperatures lower than the phase change temperature.

23. A method of starting a vehicle having a heat utilizing system, a heat storage medium that when heated undergoes a phase change at a phase change temperature, and an initiator, comprising the steps of:
starting the vehicle and the heat utilizing system;
triggering the initiator at a temperature that is below the phase change temperature, which initiates a phase change of the heat storage medium;
extracting heat from the heat storage medium; and
using the extracted heat in the heat utilizing system.
